(19) United States
(12) Patent Application Publication
(10) Pub. No.: US 2004/0170947 A1
(43) Pub. Date: Sep. 2, 2004

(54) Dental implant and bone regeneration device and method of implementation

(76) Inventor: Robert H. Milne, Portland, OR (US)

Correspondence Address: DELLETT AND WALTERS, P. O. BOX 2786, PORTLAND, OR, 97208-2786, US

(21) Appl. No.: 10/759,839

(22) Filed: Jan. 16, 2004

Related U.S. Application Data
(60) Provisional application No. 60/450,852, filed on Feb. 27, 2003.

(51) Int. Cl. A61C 8/00

(52) U.S. Cl. 433/173

(57) ABSTRACT

A dental implant and bone preservation and regeneration arrangement and method of implementation is disclosed. The dental implant arrangement includes an implant body screwed into a patient's alveolar bone. An abutment on the implant body collar portion receives a crown. The implant body, the abutment, the crown, the implant body/abutment junction or the abutment/crown junction includes a “macro-feature” such as a “macro-gap” or “macro-protrusion” large enough to encourage gingival tissue growth in and/or around the feature. The growth prevents oral bacteria from getting below the level of the macro-feature. The arrangement reduces bone loss and encourages bone regeneration. The macro-feature can be progressively repositioned to regenerate bone.

### FIELD OF THE INVENTION

This invention relates in general to dental implants and in particular to a new implant geometry that prevents unwanted bone loss and gingival recession and which can be used to regenerate bone.

### BACKGROUND OF THE INVENTION

Dental implants are known and are used to replace tooth loss from accident or disease. As shown in FIG. 1 a typical implant 10 comprises a screw or implant body 12 inserted in the patient's alveolar or jaw bone 14, and an abutment 16 attached to a collar portion 18 of the implant body 12. A crown 20 is cemented to the abutment 16. Unfortunately the bone 14 tends to recede down away from the crown 20 making the implant and the surrounding teeth less strong, stable, and healthy. Usually, as the bone recedes the gum or gingiva 22 follows downward and more of the crown 20 is exposed. The gingiva 22 tends to maintain a constant thickness generally referred to as the “biological width” which varies from person to person but is thought to remain constant for a given individual site.

It is generally accepted once the bone recedes down to the first thread 24 recession stops or significantly reduces. The gingiva would therefore stop moving downward and maintain the biological width above the bone.

FIG. 2 shows another prior art implant such as that made by the ASTRA TECH company having very fine threads 26 at the top portion of the implant body 12. The bone 14 is believed to attach better to the fine threads 26 causing less bone loss.

Another feature of the implant shown in FIG. 2 is the conical seal collar 28 which angles inward to meet the surface of a conical abutment 30. The conical abutment 30 is made as a single piece and extends into the implant body 12.

The design shown in FIG. 2 seeks to provide a stronger dental implant and seeks to provide a better seal at the implant body/abutment junction 32. FIG. 1 shows the implant body/abutment junction 34 and abutment/crown junction 36 for the prior art device discussed above. Imperfect mating at junctions 34 and 36 create what is referred to as a “micro-gap”, generally considered to be the source of irritation, inflammation, and infection because of the tendency for oral bacteria to get into the micro-gap. It has been postulated that the inflammation and infection started at the micro-gap causes the bone to recede. The gingiva is thought to follow the receding bone downward maintaining the biological width.

However, under some circumstances, such as when a patient has dilation hyperplasia, gum tissue will overgrow and be a lot thicker than average. If kept clean it will stay thick.

The inventor has discovered that purposefully providing a “macro-feature” such as a “macro-gap” or “macro-protrusion” on the dental implant large enough to encourage gingival tissue growth up to and into the gap, or around the protrusion, will impede oral bacteria from getting below the level of the macro feature thereby keeping the level of the gingival tissue up to at least the level of the macro-feature. The bone will not recede below the healthy gingiva and can also be made to regenerate.

### SUMMARY OF THE INVENTION

In accordance with the invention, there is provided a macro-feature on one of the implant body, the abutment or the crown, or at one of the implant body/abutment junction or the abutment/crown junction. The macro-feature controls gingival growth shaping the gingival tissue into a barrier to inhibit oral debris and bacteria from getting between the implant and the gingiva. The healthier gingival tissue, according to the invention stays at or above the macro-feature maintaining and/or establishing a healthy environment below reducing bone loss and/or promoting bone regeneration.

Accordingly, it is an object of the present invention to provide an improved dental implant with an improved architecture which greatly reduces gingival irritation, inflammation and irritation.

It is a further object of the present invention to provide an improved dental implant which inhibits bone loss.

It is a still further object of the present invention to provide an improved dental implant which can induce bone regeneration.

It is yet another object of the present invention to provide a device being implantable into the alveolar crest of the jaw bone which encourages gingival growth therein, and the bone regeneration device being extractable from the alveolar crest thereby positioning gingival tissue at a higher level and causing bone to regenerate at progressively higher levels.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a sectional view showing a prior art dental implant;

FIG. 2 is a sectional view showing another prior art dental implant;

FIG. 3 is a sectional view showing a first embodiment of the invention;

FIG. 4 is a sectional view showing a second embodiment of the invention;

FIG. 5 is a sectional view showing a third embodiment of the invention;

FIG. 6 is a sectional view showing a fourth embodiment of the invention;

FIG. 7 is a sectional view showing a fifth embodiment of the invention;

FIG. 8 is a sectional view showing a sixth embodiment of the invention;

FIG. 9 is a sectional view showing a seventh embodiment of the invention; and

FIG. 10 is a sectional view showing an eighth embodiment of the invention.

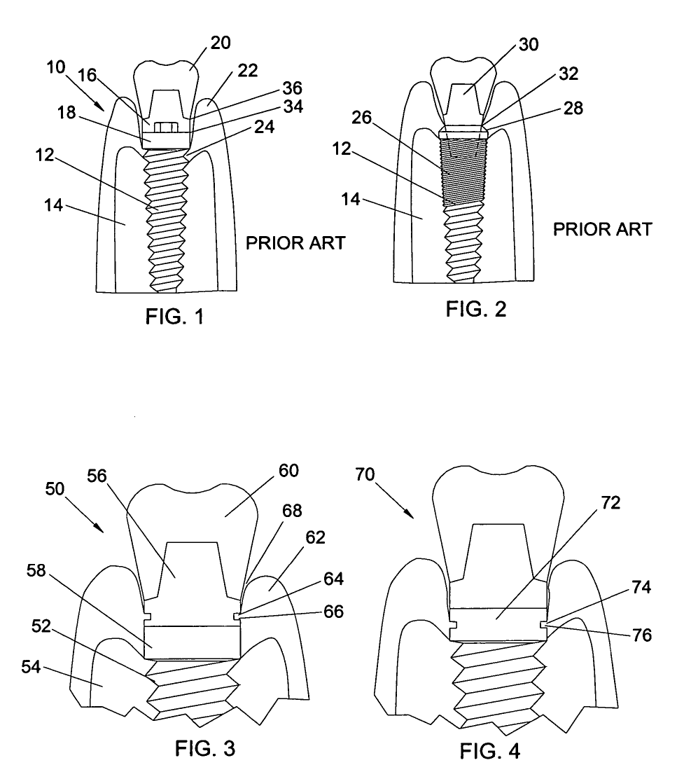

### DETAILED DESCRIPTION

The arrangement according to a preferred embodiment of the present invention is shown in FIG. 3 and comprises a dental implant identified generally by reference numeral 50. The arrangement includes an implant body 52 screwed into a patient's alveolar process 54. An abutment 56 is attached to the collar portion 58 of the dental implant 50. A crown 60 is attached to the abutment. The abutment 56 includes a circumferential macro-gap 64 into which has grown a gingival barrier 66. Debris and oral bacteria is therefore inhibited by the gingival barrier from penetrating any deeper than the level of the macro-gap 64 along the surface of the implant. The patient is then more successful at keeping the pocket 68 free of debris with normal hygiene such as brushing and flossing.

In FIG. 4 a second embodiment according to the invention 70 is shown wherein the collar portion 72 includes a macro-gap 74. A gingival barrier is shown by reference numeral 76.

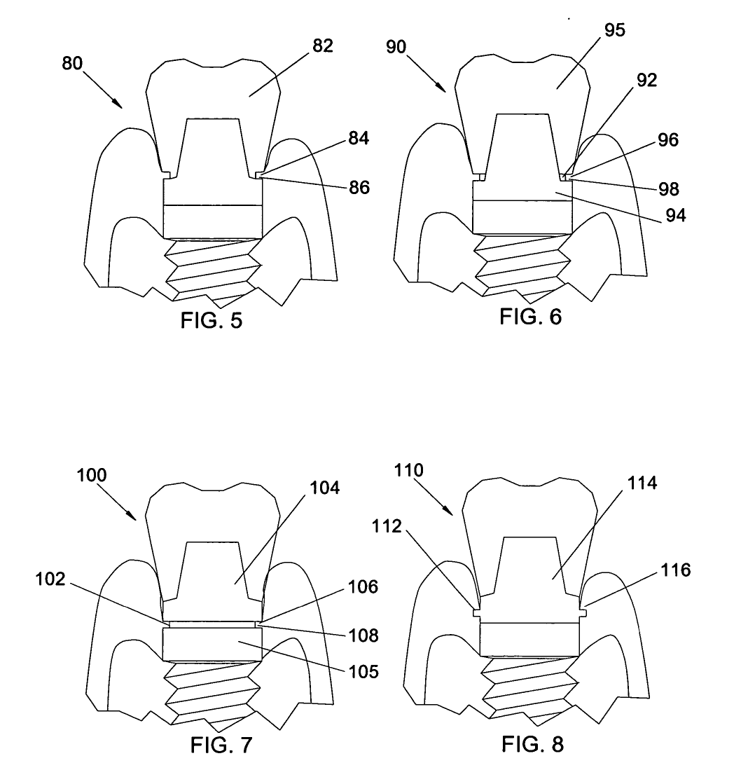

In FIG. 5 a third embodiment according to the invention 80 is shown. The bottom of the crown 82 includes a macro-gap 84. A gingival barrier is shown by reference numeral 86.

In FIG. 6 a fourth embodiment according to the invention 90 is shown. A spacer 92 is included between the abutment 94 and the crown 95 creating a macro-gap 96 according to the invention. A gingival barrier is shown by reference numeral 98.

In FIG. 7 a fifth embodiment according to the invention 100 is shown. A spacer 102 is included between the abutment 104 and the collar portion 105 creating a macro-gap 106 according to the invention. A gingival barrier is shown by reference numeral 108.

In FIG. 8 a sixth embodiment according to the invention 110 is shown. A circumferential macro-protrusion 112 extends from the abutment 114. Gingival growth has formed around the protrusion 112 forming a gingival barrier 116.

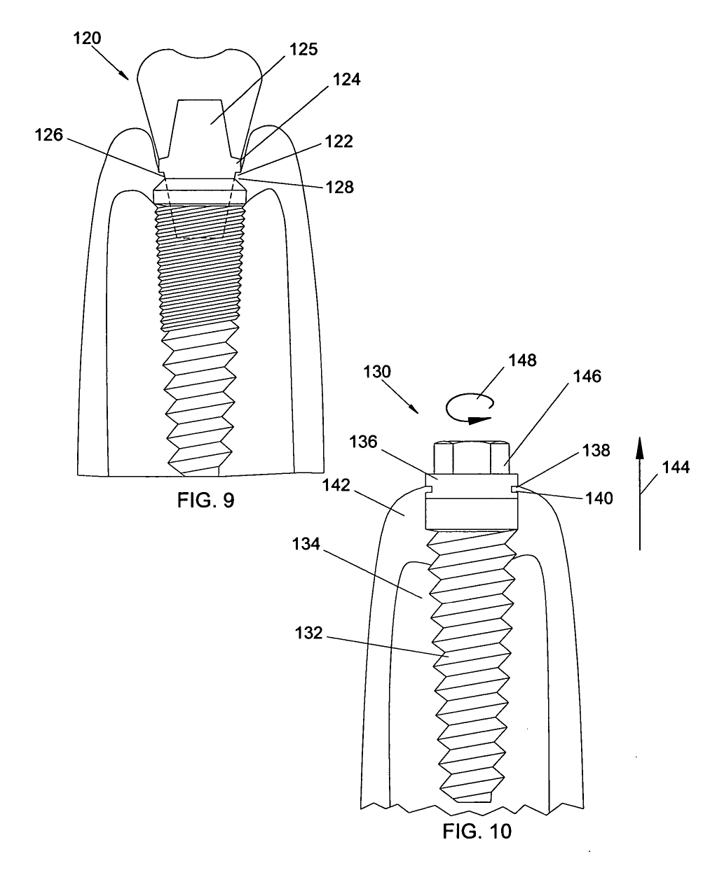

FIG. 9 shows a seventh embodiment according to the invention 120 wherein a macro-gap 122 is created between an extending portion 124 of the abutment 125 and an upwardly facing conical surface 126. A gingival barrier 128 has formed within the macro-gap 122.

FIG. 10 illustrates another very useful application of the invention. A bone regeneration device according to the invention is shown generally as 130 and has an implant body 132 screwed into the bone 134. An abutment portion 136 having a macro-gap 138 is connected to the implant body 132. Gingival tissue 140 has grown into the macro-gap 138. The main gingival body 142 has been pulled slightly in direction 144 by turning the adjustment knob 146 in direction 148. With the gingival tissue 142 pulled slightly, the bone 134 will tend to regenerate in direction 144. After some regeneration the adjustment knob 146 is turned again to pull the gingival further in direction .144. Over time a significant amount of bone regeneration can be achieved as the regeneration device 130 is moved further and further in direction 144.

It should be understood from FIG. 10 that any suitable means to progressively move a macro-feature from a bone to achieve regeneration can be used while staying within the scope of the invention.

While plural embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A device implantable into the alveolar crest comprising:
a macro-feature disposed to shape gingival tissue into a gingival barrier.

2. A device according to claim 1 wherein the device is a dental implant.

3. A device according to claim 1 wherein the device includes and adjustment means, said adjustment means enabling the device to be extractable from the alveolar crest thereby progressively moving the macro-feature away from the alveolar crest and pulling the gingival tissue further away from the alveolar crest encouraging bone regeneration on the alveolar crest in a direction away from the alveolar crest.

4. A device according to claim 2 wherein said dental implant includes an implant body being screwed into a patient's alveolar bone, said implant body having a collar portion, an abutment being attachable to said collar portion a crown being attachable to said abutment, wherein said macro-feature includes a circumferential macro-gap on said abutment disposed to enable gingival tissue to grow into said gingival barrier.

5. A device according to claim 2 wherein said dental implant includes an implant body being screwed into a patient's alveolar bone, said implant body having a collar portion, an abutment being attachable to said collar portion a crown being attachable to said abutment, wherein said macro-feature includes a circumferential macro-gap on said collar portion disposed to enable gingival tissue to grow into said gingival barrier.

6. A device according to claim 2 wherein said dental implant includes an implant body being screwed into a patient's alveolar bone, said implant body having a collar portion, an abutment being attachable to said collar portion a crown being attachable to said abutment, wherein said macro-feature includes a circumferential macro-gap on said crown disposed to enable gingival tissue to grow into said gingival barrier.

7. A device according to claim 2 wherein said dental implant includes an implant body being screwed into a patient's alveolar bone, said implant body having a collar portion, an abutment being attachable to said collar portion a crown being attachable to said abutment, a spacer between said abutment and said crown, wherein said macro-feature includes a circumferential macro-gap formed by a space created adjacent said spacer disposed to enable gingival tissue to grow into said gingival barrier.

8. A device according to claim 2 wherein said dental implant includes an implant body being screwed into a patient's alveolar bone, said implant body having a collar portion, an abutment being attachable to said collar portion a crown being attachable to said abutment, a spacer between said collar portion and said abutment, wherein said macro-feature includes a circumferential macro-gap formed by a space created adjacent said spacer disposed to enable gingival tissue to grow into said gingival barrier.

9. A device according to claim 2 wherein said dental implant includes an implant body being screwed into a patient's alveolar bone, said implant body having a collar portion, an abutment being attachable to said collar portion a crown being attachable to said abutment, wherein said macro-feature includes a circumferential macro-protrusion extending from said abutment disposed to enable gingival tissue to grow into said gingival barrier.

10. A method of regeneration jaw bone on a patient comprising the steps of:
inserting a device is into the patient's alveolar crest, the device having a macro-feature disposed to shape gingival tissue into a gingival barrier;
allowing the gingival barrier to grow; and
progressively extracting the device from the patient's alveolar crest.
